(19) United States
(12) Patent Application Publication
(10) Pub. No.: US 2008/0096503 A1
(43) Pub. Date: Apr. 24, 2008

(54) SYSTEM AND METHOD FOR DYNAMICALLY RECONFIGURING ASSOCIATIONS BETWEEN A REMOTE SITE AND A ZONE CONTROLLER IN A COMMUNICATION SYSTEM

(75) Inventors: George R. Economy, Arlington Heights, IL (US); Matthias J. Martin, Crystal Lake, IL (US); Matthew A. Baarman, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/552,031

(22) Filed: Oct. 23, 2006

(51) Int. Cl. H04B 1/18

(52) U.S. Cl. 455/187.1

(57) ABSTRACT

A system and method for dynamically re-associating remote sites among multiple zone controller. The system includes multiple zones, each having one or more zone controllers associated with multiple remote sites via a network. Upon a failure, loss of service, or other preset event, a remote site obtains a list of foreign zone controllers with which the remote site is capable of being associated with, selects one of the list of foreign zone controllers; and associates with the selected foreign zone controller.

### TECHNICAL FIELD OF THE DISCLOSURE

This invention relates generally to communication systems, and more particularly, to a system and method for dynamically reconfiguring associations between a remote site and a zone controller in a communication system.

### BACKGROUND OF THE DISCLOSURE

Communication systems typically include a plurality of dispatch consoles and communication units, such as mobile or portable radio units, that are geographically distributed among various base sites and console sites. The communication units wirelessly communicate with each other via the base sites, and are often logically divided into various talkgroups. Communication systems may be organized as trunked systems, where a plurality of radio frequency (RF) communication resources are allocated amongst multiple users or groups by assigning the base sites within a coverage area on a call-by-call basis, or as conventional (non-trunked) systems where RF communication resources are dedicated to one or more users or groups.

In trunked systems, or in mixed trunked and conventional systems, there is usually provided a central controller/server (sometimes called a “zone controller”) for allocating RF communication resources among a group of sites. The zone controller and the associated group of sites are typically referred to as a “zone.” A communication system may include multiple zones, each having a zone controller and a group of sites. Each of the zones is usually interconnected with the other zones to allow for communications between the various zones.

Typically, in order to provide redundancy in the communication system, multiple zone controllers are provided within each zone. Thus, if a main zone controller fails, the base sites originally associated with that main zone controller are switched over to a backup zone controller.

This approach, however, has numerous drawbacks. First, requiring every zone to include at least two zone controllers adds significant cost and complexity to the system. Since the backup zone controller is only used in the event that the main zone controller fails, a lot of available processing capability also remains unused in the communication system.

Additionally, if both the main and backup zone controllers fail, or are rendered inoperable for a number of reasons, for a single zone, present communication systems are not capable of automatically reconfiguring the topology of the system to re-associate sites with available zone controllers in other zones. As a result, base sites associated with such a zone would operate in a reduced operational manner.

Accordingly, there is a need for a system and method that dynamically reconfigures associations between a remote site and a zone controller in a communication system.

### BRIEF DESCRIPTION OF THE FIGURES

Various embodiment of the invention are now described, by way of example only, with reference to the accompanying figures.

FIG. 1 shows one embodiment of a single zone in a communication system according to the present disclosure.

FIG. 2 shows one embodiment of a communication system having multiple zones according to the present disclosure

FIG. 3 shows one embodiment of a process for reconfiguring a remote site association from a home zone controller to a foreign zone controller according to the present disclosure.

FIG. 4 shows one embodiment of a process for associating a remote site with the foreign zone controller according to the present disclosure.

FIG. 5 shows one embodiment of a communication system having grouped remote sites according to the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help improve the understanding of various embodiments of the present disclosure. Also, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions with respect to their corresponding respective areas of inquiry and study except where specific meaning have otherwise been set forth herein.

### DETAILED DESCRIPTION OF THE DISCLOSURE

A system and method for dynamically re-associating remote sites among multiple zone controllers is provided. The system includes multiple zones, each having one or more zone controllers associated with multiple remote sites. If a failure, loss of service, or other preset event is detected, a remote site may be re-associated with a different zone controller. The remote site may also seek to associate itself with a different zone controller if better network connectivity conditions are present at another zone. The remote site accomplishes this by determining at least one available zone controller (other than the one with which it is currently associated) with which the remote site is capable of communicating. Based on various criteria, the remote site selects one of the available zone controllers to associate itself with. Assuming the selected zone controller is capable of processing the additional load of the remote site, the remote site then associates itself with the new zone controller.

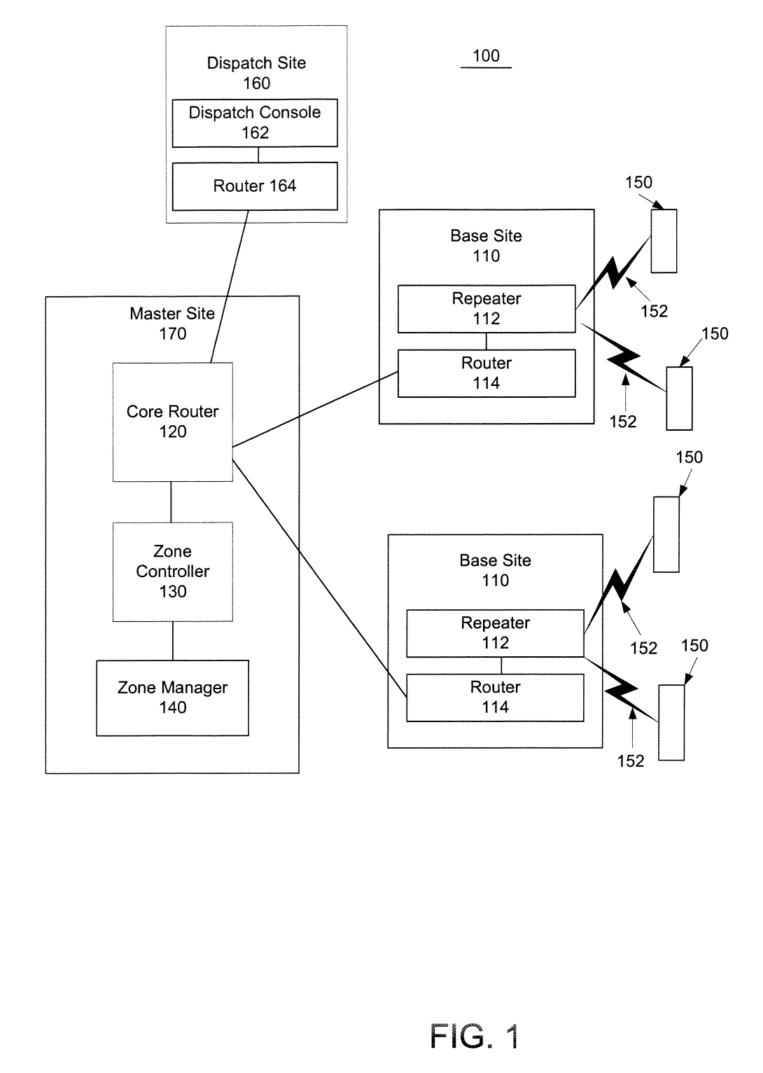

Let us now discuss the present disclosure in greater detail by referring to the figures below. FIG. 1 shows one embodiment of a single-zone communication system 100. The system 100 comprises a plurality of base sites 110 that are in communication with a core router 120. The core router is also coupled to a zone controller 130. The zone controller 130 provides overall call control for routing payload (e.g., voice, data, video, etc.) and control messages between and among the various base sites 1 10. The zone controller 130 may also be linked to zone controllers of other communication zones (not shown in FIG. 1).

The zone controller 130 is further coupled to a zone manager 140. The zone manager 140 provides fault, configuration, performance, accounting, and security management for the system equipment and communication units in the communication zone. As shown in FIG. 1, the core router 120, the zone controller 130, and the zone manager 140 are collectively referred to as a maser site 170.

Each base site 110 is comprised of at least one repeater 112 that communicates using wireless communication resources 152 with communication units 150 within a specific coverage area. The communication units 150 may be mobile or portable wireless radio units, cellular radio/telephones, video terminals, portable computers with wireless modems, or any other wireless devices. The repeaters 112 are also coupled, for example, via Ethernet, to an associated router 114, which is in turn coupled to the core router 120.

The core router 120 may also be further coupled to a dispatch site 160. As shown in FIG. 1, the dispatch site 160 includes at least one dispatch console 162 that is coupled, for example, via Ethernet to a router 164, which is in turn coupled to the core router 120. Although not shown in FIG. 1, it will be appreciated that a single remote site may include both repeaters and dispatch consoles. In one embodiment, the base sites 110, the master site 170, and the dispatch site 160 may be coupled using T1 lines, E1 lines, fiber optic lines, wireless links, Ethernet links, or any other suitable means for transporting data between the various components.

The wireless communication resources 152 used by the base sites 110 to communicate with the communication units 150 may comprise any communication resource such as, for example, RF technologies, including, but not limited to Code Division Multiple Access (CDMA), Time Division Multiple Access (TDMA), Frequency Division Multiple Access (FDMA), 802.11, and the like. The present disclosure may also be used in any of the currently available RF communication systems, such as, for example, Global System for Mobile communication (GSM), General Packet Radio Service (GPRS), Universal Mobile Telecommunications Service (UMTS), Trans-European Trunked Radio service (TETRA), Dimetra, Association of Public Safety Communication Officers (APCO) Project 25, Personal Communication Service (PCS), Advanced Mobile Phone Service (AMPS), Integrated Dispatch Enhanced Network (iDEN), and the like. Other wireless technologies, such as those now known or later to be developed and including, but not limited to, infrared, Bluetooth, electric field, electromagnetic, or electrostatic transmissions, may offer suitable substitutes.

Practitioners skilled in the art will appreciate that the system 100 may also include various other elements not shown in FIG. 1. For example, although one dispatch site and two base sites are illustrated, the system 100 may include any number of dispatch sites and base sites. The system 100 may include remote sites configured to provide simulcast transmissions, or a console site having one or more dispatch consoles. The system 100 may also be linked to a public switched telephone network (PSTN), a paging network, a facsimile machine, or the like. The communication system 100 may also be connected to a number of additional content sources, such as the Internet or various Intranets.

In one embodiment, the various components in the system, such as repeaters, dispatch consoles, zone controllers, and zone managers are all Internet Protocol (IP) host devices that are able to transport packet data representative of multimedia communications (such as voice, video, data) or control traffic to other host devices in the system. In particular, data is divided into IP packets called datagrams, which include addressing information (e.g., source and destination addresses) that enables the routers throughout the network to transport the packets to the specified destination(s). The destination addresses may identify a particular host device or may comprise an IP multicast address shared by a group of host devices.

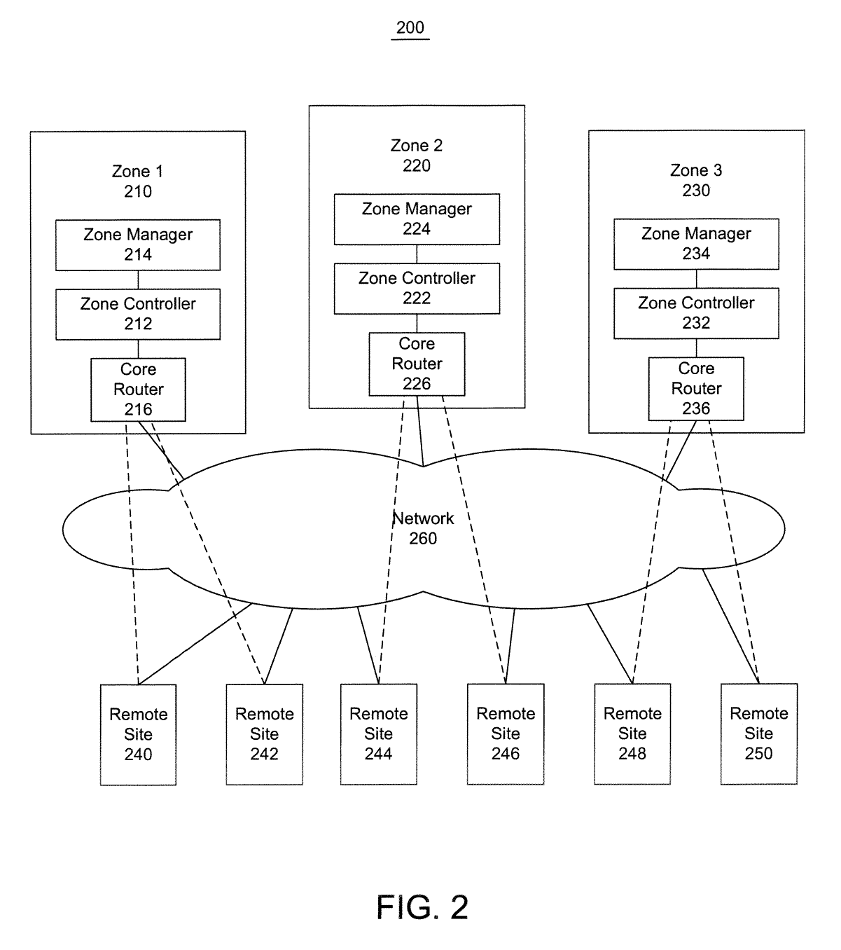

FIG. 2 illustrates a communication system 200 having multiple interconnected zones. As shown, there are three zones 210, 220 and 230, each having an associated zone controller, zone manager, and core router: zone 210 includes zone controller 212, zone manager 214 and core router 216; zone 220 includes zone controller 222, zone manager 224 and core router 226: and zone 230 includes zone controller 232, zone manager 234 and core router 236.

Each of the zones 210, 220, and 230, and more particularly each of the zone controllers 212, 222, and 232, is associated, via an IP network 260, with a plurality of remote sites 240-250. For purposes of this disclosure, the “remote site” may be a base site, a dispatch site, or any other type of site in the communication system. In FIG. 2, associations between base sites and zones are illustrated by dashed lines. Thus, remote sites 240 and 242 are associated with the zone controller 212 in zone 210, remote sites 244 and 246 are associated with zone controller 222 in zone 220 and remote sites 248 and 250 are associated with zone controller 232 in zone 230. The zone controllers 212, 222, and 232 for each zone 210, 220, and 230 respectively may also be capable of communicating with one another, via the IP network 260, in order to provide control for interzone calls. It is of course understood that although only three zones are illustrated and only two remote sites are shown as associated with each zone controller, the system may include any number of zones and any number of remote sites associated with each zone. Additionally, it should be noted that each zone may also include multiple zone controllers.

According to the present disclosure, each of the remote sites 240-250 is also capable of being dynamically re-associated, via the IP network, with at least one zone controller other than the zone controller with which it is currently associated. For example, in the system illustrated in FIG. 2, remote site 240 is capable of being associated with at least one of zone controller 222 or zone controller 232. As will be explained in further detail below, the present disclosure allows the topology of the communication system 200 to be dynamically altered in order to provide improved redundancy without reliance on a dedicated backup zone controller for each zone controller in the system. The present disclosure also permits the system 200 to dynamically alter the topology of the system in order to maximize network connectivity characteristics for each remote site.

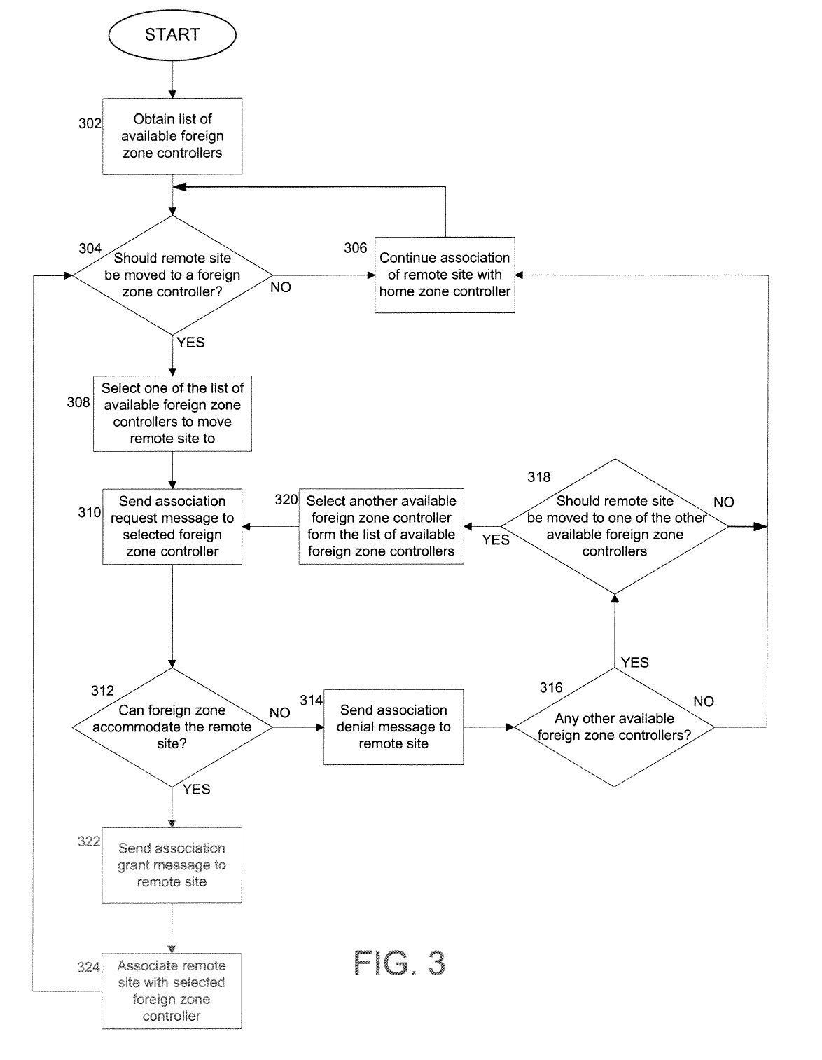

FIG. 3 illustrates one embodiment of a method for dynamically reconfiguring a remote site association from a home zone controller to a foreign zone controller. For purposes of this disclosure, a “home zone controller” is a zone controller with which the remote site is currently associated and, and a “foreign zone controller” is any zone controller other than the home zone controller. Thus, in the embodiment illustrated in FIG. 2, the home zone controller for remote sites 240 and 242 is zone controller 212, while zone controllers 222 and 232 are considered foreign zone controllers for remote sites 240 and 242. The home zone controller for remote sites 244 and 246 is zone controller 222, while zone controllers 212 and 232 are considered foreign zone controllers for remote sites 244 and 246. The home zone controller for base sites 248 and 250 is zone controller 232, while zone controllers 212 and 222 are considered foreign zone controllers for remote site 248 and 250. It should also be understood that if multiple zone controllers are included within a single zone or a single master site, another zone controller located in the same zone or master site as the home zone controller may also be considered a foreign zone controller.

In step 302, a list of available foreign zone controllers is obtained by a remote site. The list provides at least one foreign zone controller in the communication system with which a remote site is capable of being associated. The list may be comprised of each foreign zone controller in the communication, or a subset of the foreign zone controllers in the system.

In one embodiment, the foreign zone controller list may be preset by a system administrator via the zone manager. The list may also be automatically established based on various network connectivity criteria, such as the number of hops between the foreign zone controller and the remote site, packet turnaround times, and the like. Of course, the criteria used for automatically establishing the list of available foreign zone controllers may also be established by a system administrator. It should also be understood that the list may be different for each remote site.

To periodically update the list information, the remote site may also be configured to transmit a status message to each foreign zone controller in the list to determine whether each listed foreign zone controller is operational. If a foreign zone controller receiving the status message is operational, a reply message is sent back to the remote site. If the foreign zone controller is not operational, then no reply message is received and the remote site assumes that the foreign zone controller is no longer available. The status message operates similar to Packet Internet Groper (PING) message, which is well known in the art. Unlike a typical PING message, however, the status message may be a call control plane protocol message to determine not just that there is a physical connection between the remote site and the zone controller but also whether the zone controller application is operating properly.

In step 304, it is determined whether the remote site should be re-associated with a different zone controller. This determination may be made based on various events. For example, in one embodiment, if a complete failure of the home zone controller or a complete failure of the site links between the remote site and the home zone controller is detected, each remote site associated with the home zone controller may seek to move over to a foreign zone controller.

In another embodiment, other types of failures or network service losses may be detected that do no result in the complete loss of communication with the home zone controller. This may include the loss of certain redundant components (such as routers, gateways, data servers, backup zone controllers, etc.) associated with the home zone controller, traffic loads exceeding maximum specifications for the home zone controller, loss of interzone connectivity, a failure of a critical remote site such as a dispatch site, or the like. In this embodiment, depending on the nature of the failure, it may not be necessary to move each remote site associated with the home zone controller to a foreign zone controller. For example, only remote sites designated as critical or important may be moved. Of course, if the failure or network service loss is substantial, and if there are available resources at foreign zone controllers, it may also be determined that all of the remote sites should be moved to foreign zone controllers.

In another embodiment, there may be a significant decrease in the performance of the network service, such as excessively long packet turnaround times, unacceptable packet losses, or high bit error rates. In this embodiment, preset criteria established for the system, a zone, or an individual remote site may be used to determine whether the performance decrease is sufficient to warrant a move of the remote site to a foreign zone controller.

In another embodiment, a remote site may be re-associated to better allocate zone controller resources even if the performance of the home zone controller is adequate. Certain network performance characteristics may be monitored and/or obtained for the home zone controller and for each foreign zone controller on the list of available foreign zone controllers. The network performance characteristics may include the total number of remote sites associated with the zone controller, the total traffic load for the zone controller, packet turnaround times between the zone controller and associated remote sites, the number of network hops between the zone controller and the remote site, or any other characteristic. Performance levels may then be established for the home zone controllers and for each of the foreign zone controllers based on one or more of the network performance characteristics. If the performance level for one or more foreign zones controllers is sufficiently better than for the home zone controller, the remote site may be moved to one of those foreign zone controllers. As examples, a remote site may be re-associated with a foreign zone controller upon determining that a foreign zone controller has lesser traffic loads, has better network turnaround times, has less network hops between the foreign zone controller and the remote site, or any combination of these conditions or like conditions. Alternatively, the remote site may be moved only if the performance level for one or more foreign zones controller is better than that for the home zone controller, and the performance level at the home zone controller drops below a preset minimum level.

In yet another embodiment, a system administrator may schedule a specific time for a remote site, or a group of remote sites, to move from a home zone controller to a foreign zone controller. This may be done to perform maintenance or testing, or if there is a planned outage involving certain zones or the transport network.

Of course, the above scenarios are provided only as examples and are not meant to be exhaustive of all scenarios in which it may be advantageous to move a remote site to a foreign zone and one skilled in the art would readily understand other instances in which the present disclosure may be applied. It should also be understood that the determination as to whether to move the remote site to a foreign zone may be performed by the home zone controller, the remote site, or a combination of both. Thus, a remote site may choose to move to a foreign zone controller or a home zone controller may instruct the remote site to move to a foreign zone controller.

If it is determined that the remote site should not be re-associated with a foreign zone controller, the remote site remains associated with the home zone controller in step 306 and the process returns to step 304. If it is determined that the remote site should be re-associated with a foreign zone controller, the process proceeds to step 308.

In step 308, a foreign zone controller with which to re-associate the remote site is selected from the list of available foreign zone controllers. This may be accomplished based on a variety of predetermined criteria or requirements for the system and/or the particular remote site. For example, in an embodiment where the remote site is being moved in response to a detected failure or service loss, the remote site may select the “closest” foreign zone controller. The “closest” foreign zone controller may be, for example, determined by using traceroute, a UNIX command that traces the route and the number of hops between the two devices in a network.

In another embodiment, the remote site and/or the home zone controller may obtain information regarding other network performance characteristics for each available foreign zone controller, such as traffic loads, packet turnaround times, or other network connectivity information. This information may then be used, alone or in conjunction with information regarding the closeness of the foreign zones, to select a foreign zone controller in which to move the remote site. The foreign zone controller may also be selected based on the foreign zone controller with the best performance level, which may be determined as previously described above. In yet another embodiment, the foreign zone controller list obtained in step 302 may provide a preset order in which the remote site should attempt to select a foreign zone controller from the list to move to. Of course, other criteria may also be used, and each remote site may be configured to use different criteria based upon the requirement of the remote site. As with step 304, step 308 may be performed by the home zone controller, the remote site, or a combination of both.

Once a foreign zone is selected, the remote site sends an association request message to the selected foreign zone controller in step 310. Upon receiving the association request message, the selected foreign zone controller determines whether it can accommodate the remote site in step 312. For example, in one embodiment, each zone controller may have a maximum number of remote sites that can be associated with it, a maximum traffic load, or some other predetermined restriction. If associating the remote site with the selected foreign zone controller would surpass a restriction set for that foreign zone controller, the foreign zone controller may deny the remote sites requests to associate with that foreign zone controller.

If the selected foreign zone controller denies the association request, the foreign zone controller sends an association denial message to the remote site in step 314. In step 316, it is determined whether there are any other available foreign zone controllers in the list established in step 302. If there are not other available foreign zone controllers, the remote site remains associated with the home zone controller in step 306 and the process returns to step 304. If there are other available foreign zone controllers, the process proceeds to step 318.

In step 318, it is determined whether the remote site should be moved to one of the remaining available foreign zone controller if the originally selected foreign zone controller was not available. For example, if the remote site was being moved to obtain better performance or service levels than those at the home zone controller, and if no other available foreign zone controller other than the foreign zone controller selected in step 308 provides better performance levels, there may no longer be any reason to move the remote site. Of course, if the remote site was moved due to a failure or a significant service loss, there would likely still be a need to move the remote site.

If in step 318, it is determined that the remote site should not be moved to a different foreign zone controller, then the process proceeds to step 306 and the remote site remains associated with the home zone controller. If it is determined that the remote site should be moved to a different foreign zone controller, another foreign zone controller is selected from the list of available foreign zone controllers in step 320, and the process proceeds to step 310 where an association request message is transmitted to the newly selected foreign zone controller. The criteria for selecting another foreign zone controller may be similar to that described for step 308 above.

If, in step 312, the selected foreign zone controller grants the associate requests, an association grant message is sent to the remote site in step 322 and the remote site associates itself with the selected foreign zone controller in step 324. Once the remote site is associated with the selected foreign zone controller, the process returns to step 304. The process may then be repeated and the remote site may be moved again if another failure is detected, or if better performance levels are later detected at a different foreign zone controller.

In one embodiment, if a remote site was moved due to a failure, network service loss, or decrease in network performance at the home zone controller, the remote site may also be configured to periodically check whether the home zone controller has regained sufficient functionality to support the remote site. This may be accomplished by, for example, periodically sending a status message from the remote site to the home zone controller. If it is determined that the home zone controller has regained functionality, the remote site may then move back to its home zone controller.

It should also be understood that the present disclosure, when used to alter the topology of the system based on network performance levels, may be employed either continuously or at predetermined intervals. The present disclosure may also be employed during initial configuration of a communication system to automatically determine the best topology to maximize zone controller resources.

In an embodiment where the present disclosure is being used to continuously reconfigure the communication system based on performance levels at available zone controllers, a hysteresis routine may also be implemented to prevent remote sites from excessively bouncing from zone controller to zone controller. In one embodiment, a hysteresis routine may be used to limit the ability of a remote site from associating to a new zone controller if it has recently moved. For example, a remote site which moved to a new zone controller because the performance level at its home zone controller was inadequate may find that the performance level at the new zone controller has quickly dropped to a level similar to that of the original home zone controller. In this case, the hysteresis routine may require the remote site to wait until the performance level drops even further at the new foreign zone controller before searching for yet another zone controller to move to. In another example, a remote site that recently moved to a new zone controller due to an increased performance level at the new zone may be prevented from moving to yet another zone controller with even better performance until a certain amount of time has passed. Of course, other types of hysteresis routines may also be used.

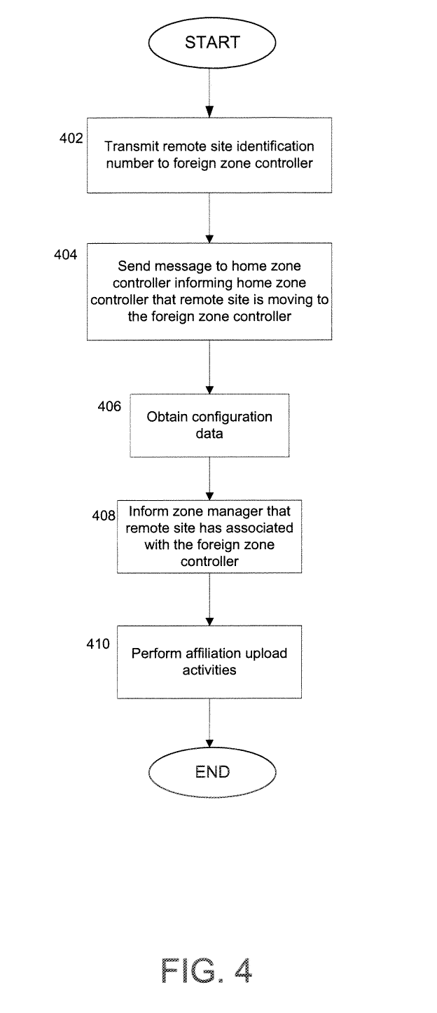

FIG. 4 illustrates one exemplary embodiment of a method for associating a remote site with a foreign zone controller according to the present disclosure. In step 402, the remote site transmits, to the foreign zone controller, an identification code for the remote site. To facilitate identification of remote sites among multiple zones in the communication system, each remote site may include a unique identification code. In one embodiment, the zone controllers in a communication system may be sequentially numbered, and the remote sites associated with each zone controller may also be sequentially numbered. The identification code for a remote site may then consist of a combination of the zone controller number and the remote site number. For example, a remote site whose home zone controller is zone controller 10 and whose current remote site number is 20 may have an identification code of 1020.

Upon receiving the identification code, the foreign zone controller and/or the remote site may attempt to inform the home zone controller that the remote site is roaming to another zone controller in step 404. Of course, if the home zone controller is no longer operational or is otherwise unable to receive communications from either the foreign zone controller or the remote site, these attempts may fail.

The foreign zone controller attempts to obtain configuration information for the remote site in step 406. In one embodiment, the zone controller may attempt to obtain the configuration information from the home zone controller. Of course, if the home zone controller is no longer operational, this may not be possible. The foreign zone controller may also request the remote site to upload its configuration information to the foreign zone controller. In another embodiment, each zone manager may store configuration information for each remote site in the system. The configuration information for a particular remote site would then be provided to the selected foreign zone controller from the zone manager upon a remote site attempting to associate with the selected foreign zone controller. Alternatively, a central manager (not shown) may also be provided and coupled with each of the zone managers in the system. Accordingly, the configuration information for each remote site may be stored at the central manager and provided to the selected foreign zone controller from the central manager upon a remote site attempting to associate with the selected foreign zone controller. Of course, other methods for obtaining configuration information may also be used. A single system may also be configured to employ any number of the methodologies described above.

In step 408, the foreign zone controller informs a zone manager associated with the foreign zone controller that the remote site has been associated with the foreign zone controller. The remote site may then be added to a user interface of the zone manager to allow a system administrator for that foreign zone controller to configure the remote site as necessary. In step 410, affiliation upload activities are performed to upload subscriber information from the remote site to the foreign zone controller.

Security protocols may also be employed to prevent unapproved remote sites from becoming associated with any of the zone controllers in the communication system, or to prevent remote sites from roaming to unapproved zone controllers. In one embodiment, this may be accomplished by providing a single router encryption key to be used for all zone controllers and remote site within a given area. In another embodiment, mutual authentication may be performed between the zone controllers and the remote sites at the application level. Other well-known security techniques may also be used.

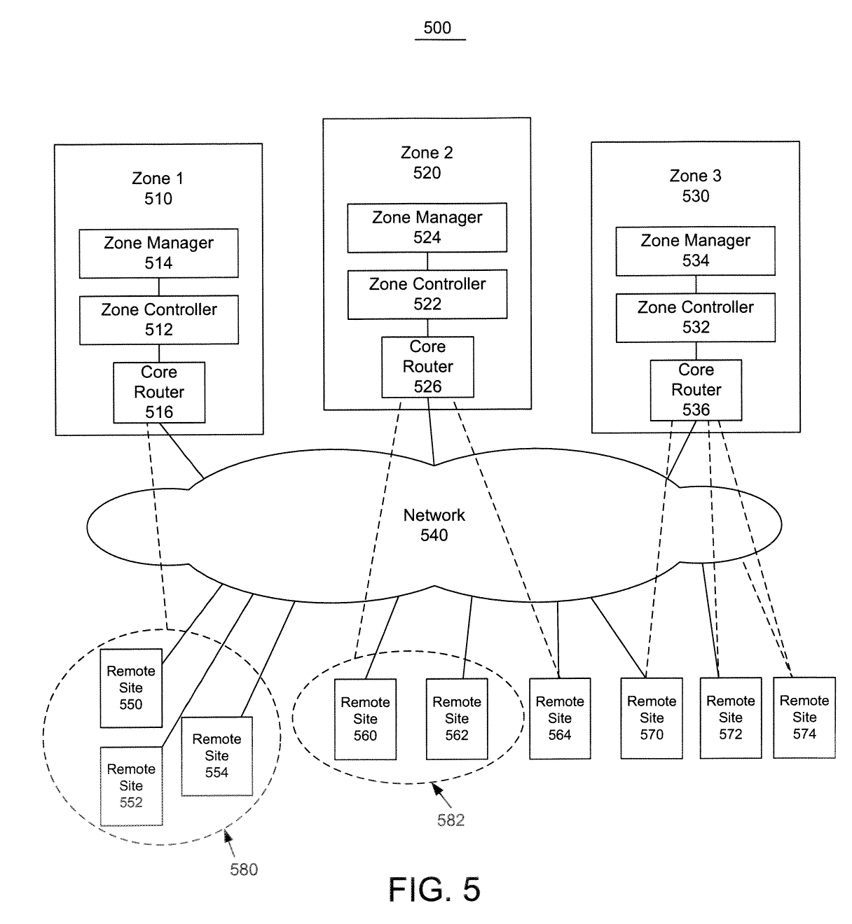

FIG. 5 illustrates another exemplary embodiment of a communication system according to the present disclosure. In this embodiment, remote sites may be grouped so that grouped remote sites may be collectively and predictably re-associated among available zone controllers. Similar to that of FIG. 2, the system of FIG. 5 includes three zones 510, 520 and 530, each having an associated zone controller, zone manager, and core router. Zone 510 includes zone controller 512, zone manager 514 and core router 516. Zone 520 includes zone controller 522, zone manager 524 and core router 526. Zone 530 includes zone controller 532, zone manager 534 and core router 536.

Each of the zones 510, 520, and 530, and more particularly each of the zone controllers 512, 522, and 532, is associated, via an IP network 540, with a plurality of remote sites. For example, zone controller 512 is associated with remote sites 550-554, zone controller 522 is associated with remote sites 560-564, and zone controller 532 is associated with remote sites 570-574.

The remote sites may also be arranged into groups. For example, as shown in FIG. 5, remote sites 550-554 may comprise a first group 580, and remote sites 560-562 may comprise a second group 582. Of course, it is understood that each zone controller may be associated with any number of groups and/or individual remote sites and each group may contain any number of remote sites.

When the topology of a communication system is reconfigured, as a result of failures, service losses, performance levels, or any other reason, the grouped remote sites will attempt to collectively associate with a foreign zone controller so that the grouped remote sites remain together at the same zone and/or with the same zone controller. There may be various reasons to group sites. In one embodiment, the remote sites may be grouped based on political reasons. For example, a given city, county, or other group may desire that certain remote sites always remain at the same zone and/or with the same zone controller. In another embodiment, remote sites may also be grouped for performance reasons. For example, performance specifications may require certain site to site call time limits, which may be violated if the remote sites are in different zones. Of course, remote sites may also be grouped for any other reason.

Within each group of remote sites, one site may be designated as a proxy site. The proxy site makes the decision for the group as to whether to move the group of remote sites to another zone controller if there is a failure or service loss, if a better performance level is detected at another zone controller, or any other criteria. As discussed above, a home zone controller may also instruct the group of remote sites to move to another zone controller.

Pertinent association information for associating with a new zone controller may also be exchanged among the remote sites in the group and aggregated at the proxy site for the group. Association information may include identification information, configuration information, subscriber information, performance information, or the like. If the group attempts to associate with a foreign zone controller, the proxy site may provide this aggregate association information to the foreign zone controller. Providing the aggregate association information minimizes the processing load on the grouped remote sites and the selected foreign zone with which the group is attempting to associate. Of course, certain association information may alternatively be sent from each remote site directly rather than being aggregated at the proxy site. For example, in one embodiment, it may be desirable to upload subscriber information directly from each remote site if there is a large amount of subscriber information that cannot be aggregated efficiently.

A priority list for all of the remote sites in a group may also be established so that a new proxy site may be designated in case the original proxy site fails. For example, in FIG. 5, remote site 550 may be the proxy site for group 580. Remote site 552 may be designated as the secondary site to assume the proxy site duties if remote site 550 fails. Remote site 554 may then be designated as the tertiary site to assume the proxy site duties if both remote site 550 and remote site 552 fail.

Although remote sites within a group attempt to move collectively when associating with a new zone controller, it should be understood that it may also be necessary to separate remote sites from the group. For example, in a scenario where a home zone controller fails, there may not be any one foreign zone controller that is capable of accommodating all the remote sites in a group. In this case, rather than leaving the remote sites associated with the failed home zone controller, the group may be split up or disbanded. For example, one or more of the remote sites may be removed from the group while the remaining remote sites attempt to associate with a single foreign zone controller. The group may also be split up into multiple groups or into individual ungrouped remote sites.

By means of the aforementioned disclosure, redundancy may be provided in a communication system without the need to provide a dedicated backup zone controller for each zone. As a result, the communication system can be configured with a lesser number of zone controllers that in prior art systems. For example, a communication system according to the present disclosure may have adequate redundancy with only a number of zone controllers equal to a number of zones—i.e., N zone controllers for N zones. Of course, if additional resources are required to ensure sufficient redundancy, a communication system with N zones may also have N+1 zone controllers, N+2 zone controllers, or any other number of zone controllers as is required by the demands of the system. The aforementioned disclosure also permits the topology of the communication system to be altered in order to best allocate all available zone controller resources to remote sites, both among zone controllers across multiple zone or across multiple zone controllers in a single zone.

Further advantages and modifications of the above described system and method will readily occur to those skilled in the art. The invention, in its broader aspects, is therefore not limited to the specific details, representative system and methods, and illustrative examples shown and described above. Various modifications and variations can be made to the above specification without departing from the scope or spirit of the present invention, and it is intended that the present invention cover all such modifications and variations provided they come within the scope of the following claims and their equivalents.

What is claimed is:

1. A method for automatically reconfiguring a zone controller association for a remote site associated with a home zone controller in a communication system, the method comprising:
obtaining a list of foreign zone controllers with which the remote site is capable of being associated with via a network, the list including at least one of a plurality of zone controllers in the communication system;
determining that the remote site should be associated with a zone controller other than the home zone controller;
selecting one of the list of foreign zone controllers; and
associating the remote site with the selected foreign zone controller.

2. The method of claim 1 wherein obtaining the list of foreign zone controllers includes transmitting a status message to at least one foreign zone controller in the communication system to determine whether the at least one foreign zone controller is operational.

3. The method of claim 1 wherein determining that the remote site should be associated with a zone controller other than the home zone controller includes detecting a failure, network service loss, or decrease in network performance associated with the home zone controller.

4. The method of claim 1 wherein determining that the remote site should be associated with a zone controller other than the home zone controller includes:
obtaining network performance characteristics for the home zone controller and at least one foreign zone controller in the list of foreign zone controllers;
determining performance levels for the home zone controller and the at least one foreign zone controller based on the network performance characteristics;
comparing the performance levels between the home zone controller and the at least one foreign zone controller; and
determining that the remote site should be associated with a zone controller other than the home zone controller if a performance level of the least one foreign zone controller is better than a performance level of the home zone controller.

5. The method of claim 1 wherein selecting a foreign zone controller includes at least one of selecting a closest foreign zone controller in the list of foreign zone controllers, selecting a foreign zone controller having a least traffic load in the list of foreign zone controllers, selecting a foreign zone controller having a shortest packet turnaround time in the list of foreign zone controllers, selecting a foreign zone controller having a best performance level in the list of foreign zone controllers, and selecting a foreign zone controller based on a preset order.

6. The method of claim 1 further including:
transmitting an association request message to the selected foreign zone controller;
receiving the association request message at the foreign zone; and
determining whether the foreign zone controller is capable of accommodating the remote site.

7. The method of claim 6 further including selecting a second foreign zone controller from the list of zone controllers if the selected foreign zone controller is not capable of accommodating the remote site, wherein the step of associating the remote site includes associating the remote site with the second selected foreign zone controller.

8. The method of claim 1 wherein associating the remote site with the selected foreign zone controller includes:
transmitting a remote site identification code from the remote site to the selected foreign zone controller;
obtaining, by the foreign zone controller, configuration information for the remote site;
informing a zone manager associated with the selected foreign zone controller that the remote site is being associated with the selected foreign zone controller; and
uploading subscriber information from the remote site to the selected foreign zone controller.

9. The method of claim 8 wherein associating the remote site with the selected foreign zone controller further includes encrypting communications between the remote site and the selected foreign zone controller.

10. The method of claim 8 wherein associating the remote site with the selected foreign zone controller further includes performing mutual authentication between the remote site and the selected foreign zone controller.

11. The method of claim 8 further including transmitting a message from at least one the of selected foreign zone or the remote site to the home zone controller to inform the home zone controller that the remote site has moved.

12. A method for reconfiguring a zone controller association for a group of remote sites associated with a home zone controller in a communication system, the method comprising:
obtaining a list of foreign zone controllers with which the group of remote sites is capable of being associated with, the list including at least one of a plurality of zone controllers in the communication system;
determining that the group of remote sites should be associated with a zone controller other than the home zone controller;
selecting one of the list of foreign zone controllers; and
associating the group of remote sites with the selected foreign zone controller.

13. The method of claim 12 wherein the group of remote sites includes a plurality of remote sites, one of which is a proxy site.

14. The method of claim 13 wherein the step of determining that the group of remote sites should be re-associated with a zone controller other than the home zone controller is performed by the proxy site.

15. The method of claim 14 wherein associating the group of remote sites with the selected foreign zone controller includes:
aggregating, at the proxy site, identification information and configuration information, for each of the plurality of remote sites in group of remote sites transmitting the aggregated identification information from the proxy site to the selected foreign zone controller;
obtaining, by the foreign zone controller, configuration information for the group of remote sites;
informing a zone manager associated with the selected foreign zone controller that the group of remote sites is being associated with the selected foreign zone controller; and
uploading subscriber information from the group of remote sites to the selected foreign zone controller.

16. The method of claim 15 wherein obtaining configuration information for the group of remote sites includes uploading the aggregate configuration information from the proxy site to the selected foreign zone controller.

17. A communication system comprising:
a plurality of zones;
a plurality of zone controllers, each one of the plurality of zone controllers being associated with one of the plurality of zones;
a plurality of remote sites coupled to the plurality of zone controllers via a network, the plurality of remote sites including at least one remote site associated with a first zone controller of the plurality of zone controllers, the at least one remote site also being capable of being associated with a subset of the plurality of zone controllers, the subset not including the first zone controller,
wherein the at least one remote site is re-associated with one of the subset of the plurality of zone controllers upon the occurrence of a predetermined event.

18. The system of claim 17 wherein the at least one remote site is a base site capable of wirelessly communicating with a plurality of communication units.

19. The system of claim 17 wherein the plurality of zones is comprised of an N number of zones and the plurality of zone controllers is comprised of X number of zone controllers, and wherein X is less than 2N.

20. The system of claim 17 where the at least one remote site includes at least two remote sites, and wherein the at least two remote sites are collectively re-associated with one of the subset of the plurality of zone controllers upon the occurrence of the predetermined event.
